(19) United States
(12) Patent Application Publication
(10) Pub. No.: US 2007/0128732 A1
(43) Pub. Date: Jun. 7, 2007

(54) Scintillator composition for a radioassay, and method for its use

(76) Inventors: Lucille Beaudet, Quebec (CA); Martin Boissonneault, Quebec (CA); Philippe Roby, Quebec (CA)

Correspondence Address: LAUREN HARMON, 1814 W. 48TH ST, CLEVELAND, OH, 44102, US

(21) Appl. No.: 10/563,047

(22) PCT Filed: Jul. 2, 2004
(86) PCT No.: PCT/US04/21639

§ 371 Date: Sep. 18, 2006

Related U.S. Application Data
(60) Provisional application No. 60/481,052, filed on Jul. 2, 2003.

(51) Int. Cl. G01N 21/75

(52) U.S. Cl. 436/166

(57) ABSTRACT

A medium for a scintillation assay includes a fluorescent Coumarin dye, typically having a Stokes shift of at least 50 nm and a fluorescence in the range of 460-500 nm. The composition may further include secondary scintillator materials which as PPO, DPA, bis-MSB, BiBuQ, and the like. The scintillator medium may be a liquid medium or a solid medium. Also disclosed is an assay utilizing the material of the present invention, as well as a specifically solid-state scintillator medium incorporating Coumarin 153 and BiBuQ.

### RELATED APPLICATION

This patent application claims priority of U.S. Provisional Patent Application Ser. No. 60/481,152, filed Jul. 2, 2003.

### FIELD OF THE INVENTION

This invention relates generally to assays. More particularly, the invention relates to scintillation assays, also known as radioassays, wherein photons produced by the interaction of a nuclear decay product with a scintillator material are detected and/or quantified. Most specifically, the invention relates to specific scintillator compositions and to their use in radioassays.

### BACKGROUND OF THE INVENTION

Scintillation counting is a widely used technique for amplifying and detecting radionuclide emission. Scintillation counting is often applied to assay methods, which are termed scintillation assays or radioassays. In such assays, a radioactive material, which may be coupled to a species being analyzed, or to another component of the assay system, is detected and/or quantified. The radioactive species typically comprises a radioisotope emitting low energy radiation. Such materials include isotopes of iodine, hydrogen, carbon, phosphorous, sulfur, and the like. In a scintillation assay, a nuclear decay product, such as a beta particle, an alpha particle, or a high energy photon, interacts with a scintillator material to produce a photon which is detected. The technique may be applied to both quantitative and qualitative assays. The scintillator material used in such assays may comprise a liquid, typically referred to as a liquid scintillation cocktail (LSC) which includes one or more scintillator materials, together with solvents, adjuncts, and the like.

In other instances, the scintillator material is a solid typically having an affinity for one of the species in the analysis system. Such solids may be comprised of beads, or liquid containment vessels, including plates, having wells formed therein. The scintillator material may be dissolved or impregnated into the solid body or it may comprise a coating, typically polymer based, applied to the solid body. Radioassays utilizing solid based scintillators are typically referred to as scintillation proximity assays (SPA). SPA assays combine the techniques of scintillation counting and radio ligand binding or radio immunoassays. Chemically, SPA assays are similar to radioassays using LSC, relying on the biochemical interaction of radiolabeled molecules to their binding partner. However, in SPA, there is no need to separate the bound from the unbound reactants. The particles emitted during the radioactive decay that are detected in SPA have a range of only a few microns in water. Therefore, in order for a radiolabeled molecule to be detected by the scintillation detector, it must be brought in close enough proximity to the scintillating matrix (beads or wells) to excite the scintillator. In a dilute suspension of radiolabeled molecules, very few molecules would be in close enough proximity to the scintillator to generate a light emission, and thus, very few of the unbound radiolabeled compounds would be detected. SPA thus allows the binding of radiolabeled compounds to be quantified.

Scintillator materials used in biological radioassays are generally classified into two broad categories. One category comprises blue scintillators, and the other, red scintillators. Blue scintillators convert the energy of radioactive decay into blue light, which is optimally detected by photomultiplier tube (PMT) detectors. Some blue scintillators comprise 9,10-diphenylanthracene (DPA) having a peak emission at about 410 nm; 2,5-diphenyloxazole (PPO), having a peak emission at about 360 nm and 1,4-bis (2-methylstyryl) benzene (bis-MSB) having a peak emission at about 426 nm. Because of their output, blue scintillators are usually poorly detected by CCD cameras. Blue light emissions are also sensitive to color quenching by yellow or brown compounds used in many screening experiments. As a result, color quench curves and algorithms are required to compensate for color quench effects when blue scintillators are used.

Red scintillators are typically based upon chelates of europium, and have a peak emission at about 610 nm, and are optimally detected by detector systems utilizing charge-coupled device (CCD) cameras. However, the emission of red scintillators is not optimal for use with PMT detectors. Shown in FIG. 1 is the spectral sensitivity of a typical PMT detector, and shown in FIG. 2 is the spectral sensitivity of a typical CCD camera detector. Red scintillators, in addition to being optimally detected by CCD cameras, also exhibit decreased sensitivity to color quenching. However, red scintillators are poorly detected by PMT-based systems.

PMT and CCD systems are both in widespread use, and each has particular advantages in specific context, and each has particular adherents. The generally incompatibility of blue scintillators with CCD detectors and red scintillators with PMT detectors is a problem which has complicated assay equipment and techniques. Accordingly, there is a need for a universal scintillator material which is compatible both with PMT and CCD detectors. Such material should have an emission which falls in a range compatible with the sensitivity of both detectors. In addition, the scintillator material should be efficient, stable, and compatible with analysis chemistries.

As will be described hereinbelow, the present invention is directed to a scintillator material which fulfills these criteria. The material of the present invention has an emission in the general range of 450-525 nm so as to be useable with both CCD and PMT detectors. In addition, the material of the present invention is stable and may be incorporated into both liquid and solid scintillator compositions.

### BRIEF DESCRIPTION OF THE INVENTION

Disclosed herein is a medium for a scintillation assay. The medium is based upon a Coumarin dye having a Stokes shift of at least 50 nm. Typical dyes of the present invention are characterized in that they have a fluorescent emission in the range of 460-500 nm, and in specific embodiments, have a Stokes shift of at least 100 nm. The medium of the present invention may include a second scintillator material such as PPO, bis-MSB, DPA, BiBuQ, and combinations thereof. The medium of the present invention may be fabricated as a solid material, or as a liquid cocktail. One specific embodiment of the present invention comprises a solid scintillator medium comprised of the dye of the present invention, and in specific embodiments further including BiBuQ incorporated therein.

Also disclosed herein is an assay methodology utilizing the material of the present invention.

### BRIEF DESCRIPTION OF THE DRAWINGS

FIG. 1 is a graphic representation of the spectral response of a typical PMT detector;

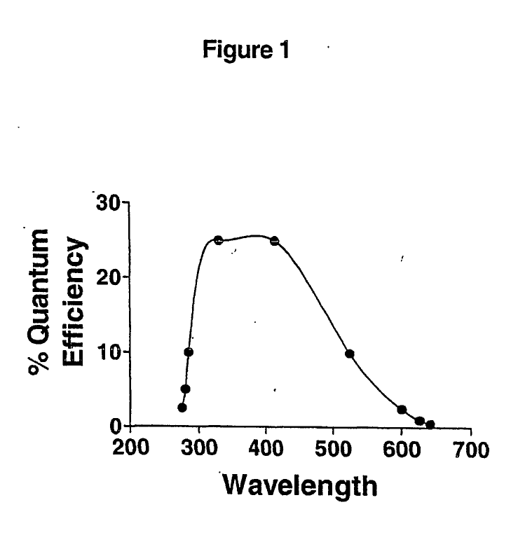

FIG. 2 is a graphic representation of the spectral response of a high efficiency CCD detector;

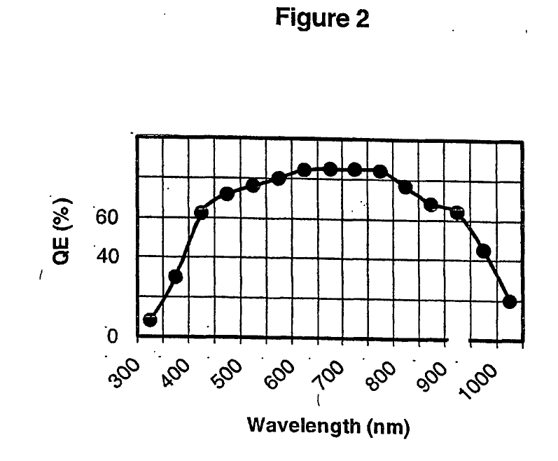

FIG. 3 is a graph showing the detected response obtained utilizing the ranged compositions of materials of the present invention;

FIG. 4 is a graphical representation of the detected response obtained utilizing various solid-state compositions of the present invention;

FIG. 5 is a graphic representation of data obtained in a specific assay of the present invention; and

FIG. 6 is a graphic representation of data obtained in another specific assay of the present invention.

### DETAILED DESCRIPTION OF THE INVENTION

The present invention relates to compositions which may be utilized as scintillator materials in radioassays. Compositions of the present invention include a Coumarin dye having a fluorescent emission in the range of 460-500 nm. The materials of the present invention are further characterized in that they have a Stokes shift of at least 50 nm, and in specific embodiments, a Stokes shift of 100 nm. As is known in the art, the Stokes shift is a characteristic of fluorescent materials and represents the differential between an exciting emission and a fluorescent emission.

The compositions of the present invention can include further scintillator materials. These may comprise any scintillator material known in the art, and some specific examples include DPA, PPO, and bis-MSB, as described above. Another auxiliary scintillator material which may be utilized in the present invention comprises 4, 4′″-DI (2-butyloctyloxy-1)-P-quaterphenyl (BiBuQ). The auxiliary scintillators act to absorb energy from the nuclear decay and transfer this energy to the Coumarin dye thereby enhancing its fluorescence. One specific Coumarin dye utilized in the present invention comprises the material known in the art as Coumarin 153, namely: 2,3,5,6-1H,4H-tetrahydro-8-trifluoromethylquinolizino-[9,9a,1-gh]-coumarin. Other Coumarin dyes known in the art such as Coumarin 152 ((7-dimethylamino)-4-(trifluoromethyl)-coumarin) may be similarly employed. In one specific embodiment of the present invention, the aforementioned Coumarin 153 is mixed with BiBuQ and is employed in scintillator beads for an SPA. In such instance, the materials are dissolved in an appropriate solvent and infused into the beads, after which the solvent is evaporated. In another embodiment of the present invention utilized as a liquid scintillation cocktail, Coumarin 153 is mixed with PPO in an appropriate solvent. In yet another embodiment of the present invention, Coumarin-based compositions are dissolved in an appropriate polymer and used to coat solid bodies such as scintillator multi-well plates.

While various Coumarin dyes have previous been employed as fluorescent and scintillator materials for non-assay applications, such materials have not been employed in a radio assay. For example, U.S. Pat. No. 4,359,641 shows a fiber-optic radiation monitor utilizing Coumarin dye compositions, including additional scintillators. Likewise, the prior art does not show solid scintillator material utilizing Coumarin dye-based compositions.

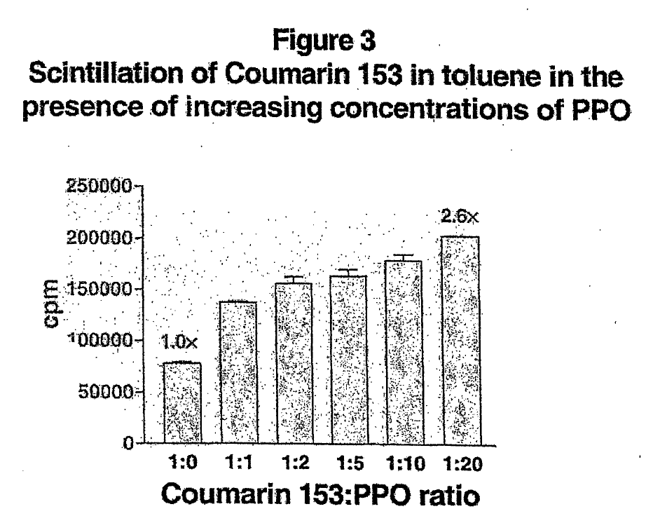

FIG. 3 illustrates the results of an experimental series demonstrating the synergistic effect of utilizing a Coumarin dye in combination with a secondary scintillator material. In this instance, a series of compositions were prepared. They comprised Coumarin 153, as well as compositions of Coumarin 153 having increasing concentrations of PPO therein. PPO functions as a primary acceptor of energy from the nuclear decay, and transfers its energy to the Coumarin thus enhancing the fluorescent emission of the Coumarin at approximately 500 nm. This demonstrates the fact that the composition of the present invention can be utilized with PMT as well as CCD detectors.

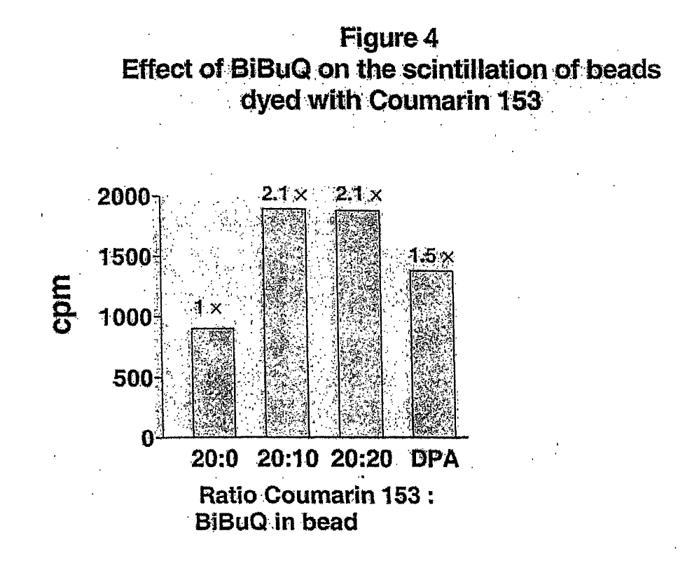

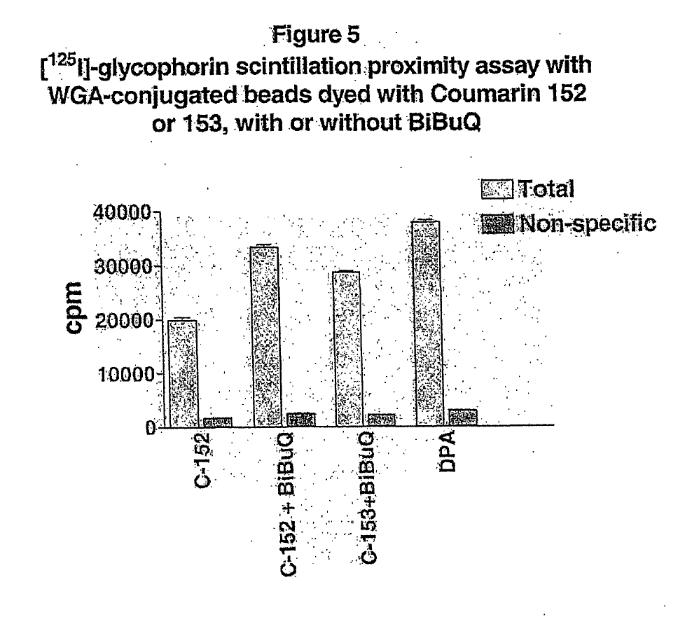

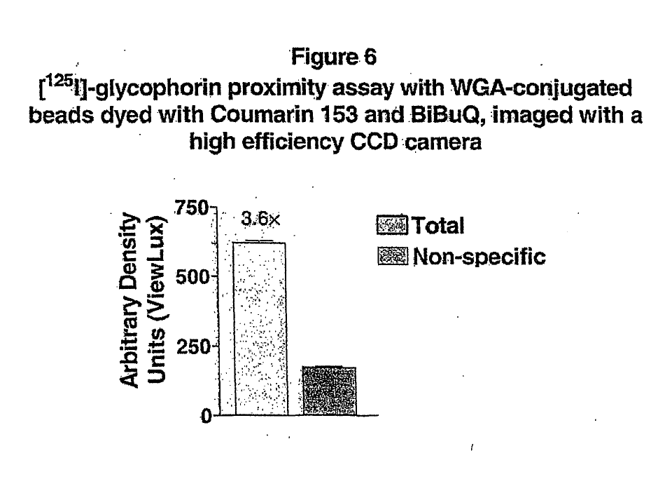

In accord with the present invention, a procedure for dyeing polystyrene beads with Coumarin 153 was developed. In the presence of 0.25 μCi tritiated scopolamine (non-specific proximity assay), carboxylated PS beads dyed with Coumarin 153 generated a scintillation signal, which not as strong as that produced by beads dyed with DPA (FIG. 4). However, when beads were dyed with was a mixture of Coumarin 153 and BiBuQ, their scintillation doubled (FIG. 4). Beads conjugated to WGA were tested in an I¹²⁵-glycophorin proximity assay (FIG. 5). Beads dyed with both BiBuQ and Coumarin 153 generated a signal comparable to the signal measured with DPA beads (FIG. 5). The peak of emission of Coumarin 153 in polystyrene beads is at ˜490 nm. Coumarin 152 was also shown to be a potent scintillator for SPA beads, alone or with BiBuQ (FIG. 5). Its peak of emission in polystyrene beads is ˜460 nm. One of the advantages brought by the invention is the possibility of detecting the light emission of the scintillating matrix or LCS with either PMT-based instruments and CCD imagers. FIG. 6 shows a glycophorin assay performed with beads dyed with a mixture of Coumarin 153 and BiBuQ and imaged with a high-efficiency CCD camera (ViewLux). The results show a 3.6 fold signal to background ratio. Further optimization of the beads dyeing and WGA attachment procedures should lead to beads with improve performance with both PMT-based readers and CCD cameras imagers.

Coumarin 153 and 152 have a Stokes shift of over 100 nm. Other Coumarin dyes with large Stokes shifts can also be used in the composition. The ideal Coumarin dyes for the composition have Stokes shifts of more than 50 nm, preferably more than 100 nm, to minimize self-quenching of light emission, and have a peak of emission around 500 nm. Other additional scintillators could also be used in the invention to replace PPO or BiBuQ, as long as they can transfer their energy efficiently to the acceptor Coumarin dye. DPA could eventually be used as a primary (or additional) acceptor dye. The dye compositions of the invention are either incorporated into particles or in the wells of a plate, or in any other matrix that can be used in scintillation proximity assays, or in a fluoro solvent for LSC. Beads dyed with Coumarin 153 emit light at a longer wavelength (˜490 nm) compared to DPA beads (˜410 nm). Red-shifted light emission helps reducing the color quench caused by yellow or brownish compounds absorbing the light emission of scintillants emitting around 400 nm. A major improvement of this composition over either existing scintillating products is that the light emission of beads dyed with Coumarin and BiBuQ (or PPO) is in a range that allows detection with both conventional readers equipped with photomultiplier tubes and CCD imagers.

The foregoing discussion, description and examples illustrate some specific embodiments of the present invention; but is not to be a limitation upon the practice thereof. In view thereof, other modifications and variations of the invention will be apparent to those of skill in the art. It is the following claims, including all equivalents, which define the scope of the invention.

1. A medium for a scintillation assay, said medium comprising:
a first scintillator material which is a fluorescent Coumarin dye having a Stokes shift of at least 50 nm.

2. The medium of claim 1, wherein said dye is further characterized in that it has a fluorescent emission in the range of 460-500 nm.

3. The medium of claim 1, wherein said dye has a Stokes shift of at least 100 nm.

4. The medium of claim 1, wherein said medium further includes a second scintillator material.

5. The medium of claim 4, wherein said second scintillator material is selected from the group consisting of: PPO, bis-MSB, DPA, and combinations thereof.

6. The medium of claim 1, wherein said medium is a solid polymer having said Coumarin dye incorporated therein.

7. The medium of claim 6, further including BiBuQ incorporated therein.

8. The medium of claim 1, wherein said medium comprises a liquid having said Coumarin dye dissolved therein.

9. A method for carrying out an assay for detecting or quantifying a radio nuclide emission, said method comprising the steps of:
providing a scintillation medium which contains a first scintillator material which is a Coumarin dye having a Stokes shift of at least 50 nm;
contacting said scintillation medium with an analyte suspected of having said radionuclide therein; and
detecting any scintillation caused in said medium by said radionuclide.

10. The method of claim 9, wherein said Coumarin dye is further characterized in that it has a fluorescent emission at 460-500 nm.

11. The method of claim 9, wherein said Coumarin dye has a Stokes shift of at least 100 nm.

12. The method of claim 9, wherein said scintillation medium is a solid member.

13. The method of claim 9, wherein said scintillation medium is a liquid.

14. The method of claim 9, wherein said scintillation medium further includes a second scintillator material.

15. The method of claim 14, wherein said second scintillator material is selected from the group consisting of: PPO, bis-MSB, DPA, BiBuQ, and combinations thereof.

16. A solid state member for a scintillation proximity assay, said member comprising:
a polymeric material having a first scintillator material which is a fluorescent Coumarin dye incorporated therein, said Coumarin dye further characterized in that it has a Stokes shift of at least 50 nm.

17. The member of claim 16, wherein said dye is further characterized in that it has a fluorescent emission in the range of 460-500 nm.

18. The member of claim 16, wherein said dye is further characterized in that it has Stokes shift of at least 100 nm.

19. The member of claim 16, wherein said Coumarin dye is selected from the group consisting of Coumarin 153, Coumarin 152, and combinations thereof.

20. The member of claim 16, further including a second scintillator material therein.

21. The member of claim 20, wherein said second scintillator material is selected from the group consisting of: PPO, bis-MSB, DPA, BiBuQ, and combinations thereof.

22. The member claim 16, wherein said polymeric material is configured as a bead.

23. The member of claim 16, wherein said polymeric material is configured as a vessel for retaining a liquid.

24. The member of claim 16, wherein said polymeric material is applied to the surface of a vessel configured to retain a liquid.

25. A liquid scintillation cocktail comprising:
a first scintillator material which is a fluorescent Coumarin dye having a Stokes shift of at least 50 nm; a second scintillator material selected from the group consisting of: PPO, bis-MSB, DPA, combinations thereof; and
a solvent for said first and second scintillator materials.

26. The liquid scintillation cocktail of claim 25, wherein said Coumarin dye is further characterized in that it has a fluorescent emission in the range of 460-500 nm.

27. The liquid scintillation cocktail of claim 25, wherein said Coumarin dye is further characterized in that has a Stokes shift of at least 100 nm.
